(19) United States
(12) Patent Application Publication
(10) Pub. No.: US 2026/0299154 A1
(43) Pub. Date: Oct. 1, 2026

(54) SELF-SUPERVISED LEARNING WITH CROSS-TRAINING BETWEEN CONVOLUTIONAL NEURAL NETWORK AND TRANSFORMER FOR LOW-FREQUENCY ENHANCEMENTS

(71) Applicant: Schlumberger Technology Corporation, Sugar Land, TX (US)

(72) Inventors: Hengyu Tang, Houston, TX (US); Chaoshun Hu, Houston, TX (US)

(21) Appl. No.: 19/564,325

(22) Filed: Mar. 12, 2026

Related U.S. Application Data
(60) Provisional application No. 63/776,447, filed on Mar. 24, 2025.

(51) Int. Cl. G01V 1/36; G01V 1/28; G01V 1/38; G06N 3/045; G06N 3/0895

(52) U.S. Cl. CPC G01V 1/364; G01V 1/282; G01V 1/3808; G06N 3/045; G06N 3/0895; G01V 2210/23

(57) ABSTRACT

A method for enhancing seismic data comprises receiving seismic data associated with a subsurface formation, training a convolutional neural network and a transformer neural network in a self-supervised cross-training framework, and applying the trained transformer neural network to the seismic data to generate enhanced seismic data. The training includes generating training pairs by applying high-pass filtering to the seismic data, generating a first prediction from the convolutional neural network and a second prediction from the transformer neural network using the training pairs, and establishing bidirectional flow of outputs between the convolutional neural network and the transformer neural network.

### CROSS-REFERENCE TO RELATED APPLICATION

This application claims the benefit of U.S. Provisional Application No. 63/776,447, filed Mar. 24, 2025, which is incorporated by reference herein in its entirety.

### INTRODUCTION

### Field of the Disclosure

The present disclosure relates to seismic data processing using machine learning and, more particularly, to a machine learning framework for enhancing low-frequency signals in seismic data to improve full-waveform inversion results.

### DESCRIPTION OF RELATED ART

A reservoir can be a subsurface formation that can be characterized at least in part by its porosity and fluid permeability. As an example, a reservoir may be part of a basin such as a sedimentary basin. A basin can be a depression (e.g., caused by plate tectonic activity, subsidence, etc.) in which sediments accumulate. As an example, where hydrocarbon source rocks occur in combination with appropriate depth and duration of burial, a petroleum system may develop within a basin, which may form a reservoir that includes hydrocarbon fluids (e.g., oil, gas, etc.).

Drilling decisions, well placement strategies, and reservoir development plans depend on understanding the geological structures and rock properties beneath the Earth's surface. Seismic surveys represent a primary technique for acquiring information about subsurface formations, where acoustic energy is transmitted into the ground and reflected signals are recorded by sensors to generate images of geological features.

Seismic data processing transforms raw recorded signals into interpretable subsurface images that guide exploration and production activities. The quality of velocity models derived from seismic data directly impacts the accuracy of depth imaging and the reliability of reservoir characterization. Velocity model building techniques, including full-waveform inversion, seek to extract detailed information about subsurface wave propagation speeds from recorded seismic observations. The availability of low-frequency seismic content plays a significant role in constraining velocity models and reducing ambiguities in the inversion process.

Full-waveform inversion (FWI) is a tool for obtaining reliable, high-resolution seismic images of the subsurface. FWI aims to find an optimal velocity model using gradient-based optimization methods to minimize misfits between observed data and synthetic data generated from an initial model. However, as a nonconvex and nonlinear problem, FWI may become trapped in local minima when the starting model is not sufficiently accurate. Various robust misfit functions have been designed to mitigate FWI cycle skipping, but these approaches are often unsuccessful when the velocity model is complex and the initial model deviates substantially from the true model.

Developments in both acquisition technology and signal processing have enabled ocean bottom node (OBN) seismic data acquisition to be widely considered as a technique for monitoring hydrocarbon production and exploring for new reserves. OBN acquisition enables measuring long-offset refracted and diving waves, facilitating FWI-based velocity and imaging improvements in complex geologies. Compared to acoustic FWI, the nonlinearity of elastic FWI (EFWI) is more severe due to short S-wave propagation wavelength. Moreover, low-frequency components (for example, below approximately 3.0 Hz) are often tainted by noise in real seismic exploration. Retrieving reliable low-frequency signals offers a pathway to relieve the dependence of EFWI on the starting model.

Accordingly, there exists a desire for improved systems and methods for enhancing low-frequency signals in seismic data that can address one or more of the foregoing challenges.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a method for enhancing seismic data is provided. The method comprises receiving seismic data associated with a subsurface formation. The method further comprises training a convolutional neural network and a transformer neural network in a self-supervised cross-training framework. The training includes generating training pairs by applying high-pass filtering to the seismic data. The training further includes generating, using the training pairs, a first prediction from the convolutional neural network and a second prediction from the transformer neural network. The training further includes establishing bidirectional flow of outputs between the convolutional neural network and the transformer neural network. The method further comprises applying the trained transformer neural network to the seismic data to generate enhanced seismic data.

Other aspects provide: a system operable, configured, or otherwise adapted to perform any one or more of the aforementioned methods and/or those described elsewhere here; an apparatus operable, configured, or otherwise adapted to perform any one or more of the aforementioned methods and/or those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The foregoing general description of the illustrative embodiments and the following detailed description thereof are merely exemplary aspects of the teachings of this disclosure and are not restrictive.

### BRIEF DESCRIPTION OF DRAWINGS

The appended figures illustrate only exemplary embodiments and are therefore not to be considered limiting of the scope of the disclosure, as the disclosure may admit to other equally effective embodiments.

FIG. 1 depicts collection of acoustic data collected by an example seismic data system.

FIG. 2 depicts collection of seismic data during drilling operation.

FIG. 3 depicts collection of seismic data during a wireline operation.

FIG. 4 depicts collection of seismic data during a production operation.

FIG. 5 depicts seismic data acquisition from an example oilfield.

FIG. 6 depicts seismic data acquisition from another example oilfield.

FIG. 7 depicts a flow diagram of operations for enhancing seismic data.

FIG. 8 depicts a self-supervised cross-training framework for a convolutional neural network (CNN) and transformer neural network to enhance seismic data.

FIG. 9 depicts an example system for enhanced seismic data processing.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for enhancing low-frequency signals in seismic data using self-supervised learning with cross-training between convolutional neural networks and transformer neural networks.

Full-waveform inversion (FWI) is a tool for obtaining high-resolution seismic images of the subsurface. As a nonconvex and nonlinear problem, FWI may become trapped in local minima when the starting model is not sufficiently accurate. Low-frequency components of seismic data, particularly those below approximately 3.0 Hz, are often tainted by noise in real seismic exploration, especially in ocean bottom node (OBN) surveys where acquisition noise from ocean currents, instrument coupling effects, and ambient seismic sources masks the low-frequency signals. The absence of usable low-frequency signals creates challenges for FWI applications, as low-frequency content provides constraints on large-scale velocity variations that guide the inversion toward geologically valid solutions and help mitigate cycle-skipping issues. Additionally, while transformer-based approaches have demonstrated superior performance in capturing long-distance dependencies compared to convolutional neural networks, transformers present as data-hungry approaches that tend to have difficulty distinguishing real signal energy from background noise, and training instability is a major issue that degrades accuracy in self-supervised scenarios where clean ground truth targets are unavailable.

The present disclosure addresses these problems through a self-supervised learning framework that employs cross-training between a convolutional neural network and a transformer neural network to enhance low-frequency signals in seismic data. The method comprises receiving seismic data associated with a subsurface formation, training the convolutional neural network and transformer neural network in a self-supervised cross-training framework that includes generating training pairs by applying high-pass filtering to the seismic data, generating predictions from both neural networks using the training pairs, and establishing bidirectional flow of outputs between the networks, and then applying the trained transformer neural network to generate enhanced seismic data. The cross-training mechanism generates pseudo-labels for each neural network using output from the other neural network, enabling mutual optimization and constraint that stabilizes the training process. The training may proceed through a warm-up stage using band-limited seismic training data having higher-frequency content than a target low-frequency band and in which raw field data is used as the training target, followed by an iterative data refinement stage where pseudo-labels generated from previous iterations serve as training targets. Different high-pass filter cutoff frequencies may be independently sampled for each neural network to introduce perturbations in input data distributions, and Gaussian noise may be added during training to improve model robustness. A hybrid loss function based on amplitude loss, frequency loss, and reconstruction loss may be employed to oversee low-frequency extrapolation.

The cross-training framework provides several technical advantages. The method effectively removes collection noise resulting in enhancement of existing low-frequency signals in seismic collections, and extrapolates low-frequency events from high-frequency counterparts by learning highly non-linear mappings. The enhanced low-frequency content enables elastic full-waveform inversion to proceed from lower starting frequencies, which reduces cycle-skipping artifacts and improves convergence to geologically valid velocity models, particularly when good initial velocity models are unavailable. The framework maintains training efficiency by integrating sparse attention to remove irrelevant features. The method demonstrates effectiveness when trained on a small fraction (e.g., one to five percent) of OBN-acquired field data while delivering consistent performance with good generalization across different geology and at various signal-to-noise ratios. The trained model may be fine-tuned for different geological regions using only a small fraction of data from the new region, and may be directly applied to different types of acquisitions such as streamer data without modification or retraining. The methodology can be easily applied to different geological regions without needing extensive adjustments to the model building process, meeting generalization requirements for production applications.

Reference will now be made in detail to aspects, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits and networks have not been described in detail so as not to unnecessarily obscure aspects.

Certain aspects provide methods, techniques, systems, apparatus, a computer readable medium for planning, forecasting, and/or optimizing production related systems (e.g., model selections, reservoir maps, wells, etc.). Aspects described herein may be combined and/or the order of operations may be changed.

### Example Acoustic Survey Systems in a Wellbore

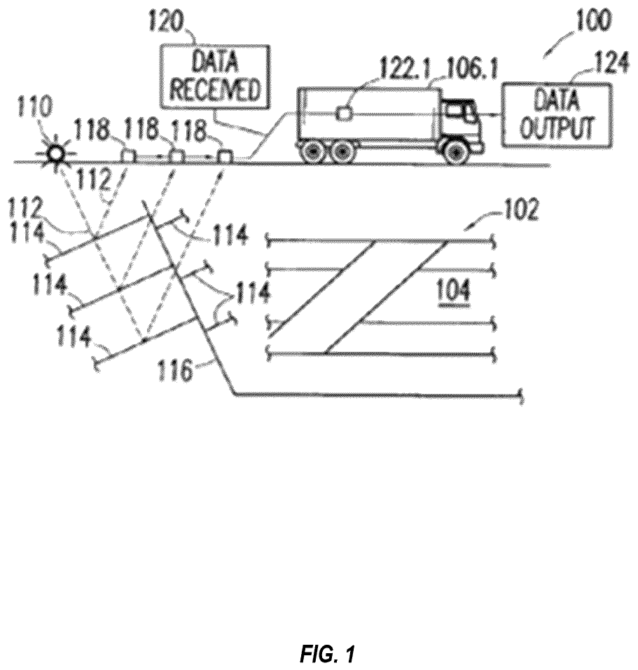

FIG. 1-6 depict an example acoustic survey system in a wellbore.

Oil and gas drilling operations involve the exploration and production of hydrocarbon resources from subsurface formations. Subsurface formations may contain reservoirs that store hydrocarbons such as oil and natural gas within porous rock structures. The identification, characterization, and development of these reservoirs may employ various technologies and techniques to maximize resource recovery while minimizing operational costs and environmental impact.

Exploration activities may begin with geological and geophysical surveys designed to identify potential hydrocarbon-bearing formations beneath the Earth's surface. Seismic surveys represent one approach for imaging subsurface structures, where acoustic energy is transmitted into the ground and reflected signals are recorded by sensors positioned at the surface or within boreholes. The recorded seismic data may be processed and analyzed to generate images of subsurface geological features, including potential reservoir formations, fault structures, and stratigraphic boundaries.

Reservoir characterization may involve the integration of multiple data sources to develop an understanding of subsurface conditions. Well logs, core samples, and production data may be combined with seismic interpretations to build geological models that describe reservoir geometry, rock properties, and fluid distributions. These models may guide decisions regarding well placement, completion strategies, and production optimization.

Drilling operations may be conducted using rotary drilling techniques, where a drill bit attached to a drill string is rotated to penetrate rock formations and create a wellbore extending from the surface to the target reservoir. Drilling fluids, also referred to as drilling mud, may be circulated through the drill string and up the annular space between the drill string and the wellbore wall to cool the drill bit, remove rock cuttings, and maintain wellbore stability. Measurement-while-drilling (MWD) and logging-while-drilling (LWD) tools may be incorporated into the bottom hole assembly to acquire real-time data regarding formation properties and wellbore conditions during drilling operations.

Upon reaching the target formation, well completion operations may be performed to prepare the wellbore for production. Completion activities may include installing casing and cement to provide structural integrity and zonal isolation, perforating the casing to establish communication with the reservoir, and installing production tubing and surface equipment to facilitate fluid flow from the reservoir to surface facilities.

Production operations may involve managing fluid flow from the reservoir through the wellbore to surface processing facilities. Reservoir management strategies may be employed to optimize hydrocarbon recovery over the productive life of the field. Enhanced oil recovery techniques, including water flooding, gas injection, and chemical treatments, may be applied to improve recovery factors beyond what primary production mechanisms can achieve.

### Example Seismic Surveying:

Seismic data acquisition represents a foundational technique in oil and gas exploration and production activities. Seismic surveys may be conducted to generate images of subsurface geological structures by transmitting acoustic energy into the Earth and recording the reflected signals that return to the surface. The acoustic waves may propagate through different rock layers and reflect at boundaries where acoustic impedance changes occur, such as at interfaces between different lithologies or between rock and fluid-filled pore spaces.

FIG. 1 depicts collection of acoustic data by a survey tool, such as a seismic truck 106.1, to measure properties of the subterranean formation 116 by producing sound vibrations. As shown in FIG. 1, a sound vibration 112 generated by source 110, reflects off horizons 114 in earth formation 116. A set of sound vibrations is received by sensors, such as geophone-receivers 118, situated at the surface. The data 120 is provided as input data to a computer 122.1 of the seismic truck 106.1. Responsive to the input data 120, the computer 122.1 generates seismic data output 124. This seismic data output 124 may be stored, transmitted or further processed as desired, for example, by data reduction.

### Example Seismic Surveying During Drilling:

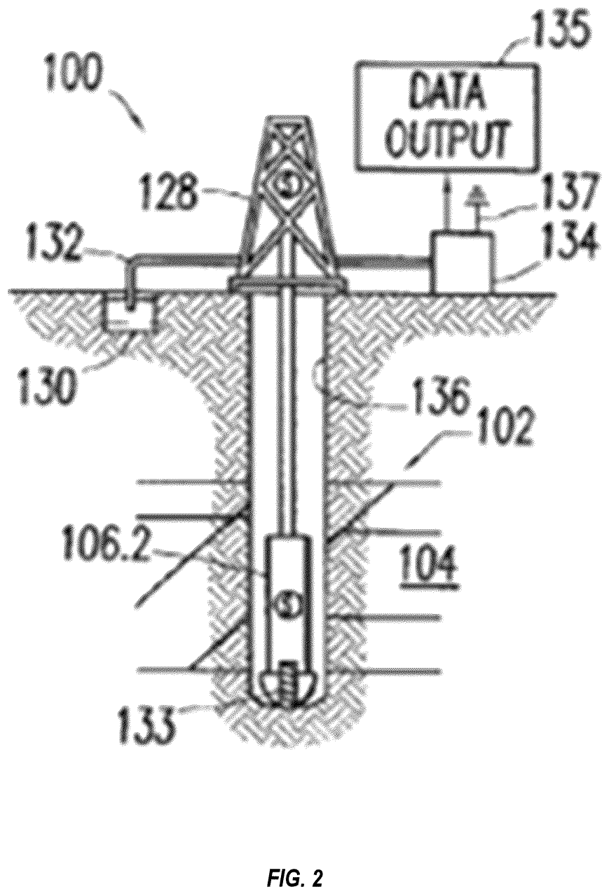

FIG. 2 depicts collection of seismic data during a drilling operation. As shown, a wellbore 136 may be drilled by drilling tools 106.2 suspended by rig 128 and advanced into subterranean formations 102 to form wellbore 136. Mud pit 130 may be used to draw drilling mud into the drilling tools via flow line 132 for circulating drilling mud down through the drilling tools, then up wellbore 136 and back to the surface. The drilling mud may be filtered and returned to the mud pit. A circulating system may be used for storing, controlling, or filtering the flowing drilling mud. The drilling tools 106.2 are advanced into subterranean formations 102 to reach reservoir 104. Each well may target one or more reservoirs. The drilling tools 106.2 may be adapted for measuring downhole properties using logging-while-drilling (LWD) tools. The LWD tools may also be adapted for taking core sample 133.

Computer facilities may be positioned at various locations about the oilfield 100 (e.g., the surface unit 134) and/or at remote locations. Surface unit 134 may be used to communicate with the drilling tools 106.2 and/or offsite operations, as well as with other surface or downhole sensors. Surface unit 134 is capable of communicating with the drilling tools 106.2 to send commands to the drilling tools 106.2, and to receive data therefrom. Surface unit 134 may also collect data generated during the drilling operation and produce data output 135, which may then be stored or transmitted.

Sensors(S), such as gauges, may be positioned about oilfield 100 to collect data relating to various oilfield 100 operations. As shown, sensor(S) is positioned in one or more locations in the drilling tools 106.2 and/or at rig 128 to measure drilling parameters, such as weight on bit, torque on bit, pressures, temperatures, flow rates, compositions, rotary speed, and/or other parameters of the field operation. Sensors(S) may also be positioned in one or more locations in the circulating system.

Drilling tools 106.2 may include a bottom hole assembly (BHA) (not shown), generally referenced, near the drill bit (e.g., within several drill collar lengths from the drill bit). The BHA includes capabilities for measuring, processing, and storing information, as well as communicating with surface unit 134. The BHA further includes drill collars for performing various other measurement functions.

The BHA may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters.

Typically, the wellbore 136 is drilled according to a drilling plan that is established prior to drilling. The drilling plan typically sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected

The data gathered by sensors(S) may be collected by surface unit 134 and/or other data collection sources for analysis or other processing. The data collected by sensors(S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

### Example Seismic Surveying During Wireline:

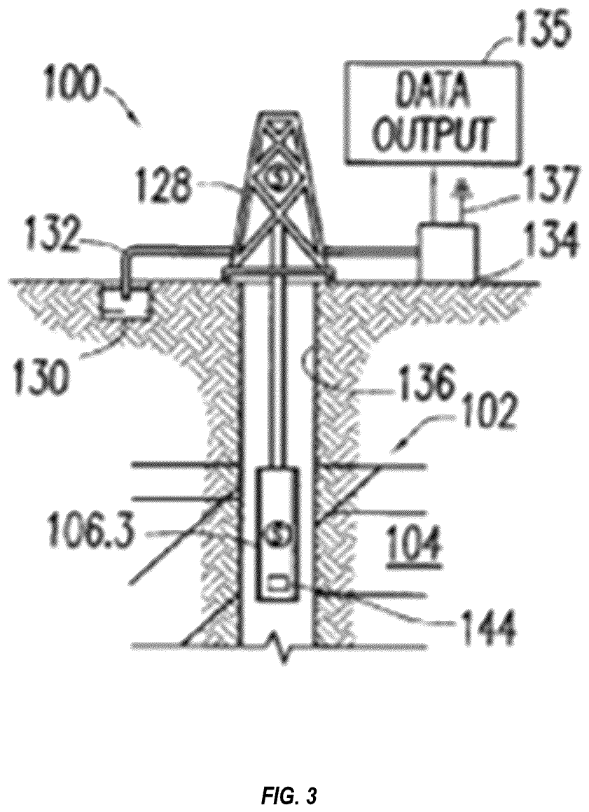

FIG. 3 depicts collection of seismic data during a wireline operation. As shown, the wireline operation may be performed by a wireline tool 106.3 suspended by rig 128 and into wellbore 136. Wireline tool 106.3 is adapted for deployment into wellbore 136 for generating well logs, performing downhole tests and/or collecting samples. Wireline tool 106.3 may be used for performing a seismic survey operation. For example, wireline tool 106.3 may have an explosive, radioactive, electrical, or acoustic energy source 144 that sends and/or receives electrical signals to surrounding subterranean formations 102 and fluids therein.

Wireline tool 106.3 may be operatively connected to, for example, geophones 118 and a computer 122.1 of the seismic truck 106.1. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors(S), such as gauges, may be positioned about oilfield 100 to collect data relating to various field operations. As shown, sensor S is positioned in wireline tool 106.3 to measure downhole parameters which relate to, for example porosity, permeability, fluid composition and/or other parameters of the field operation.

### Example Seismic Surveying During Production:

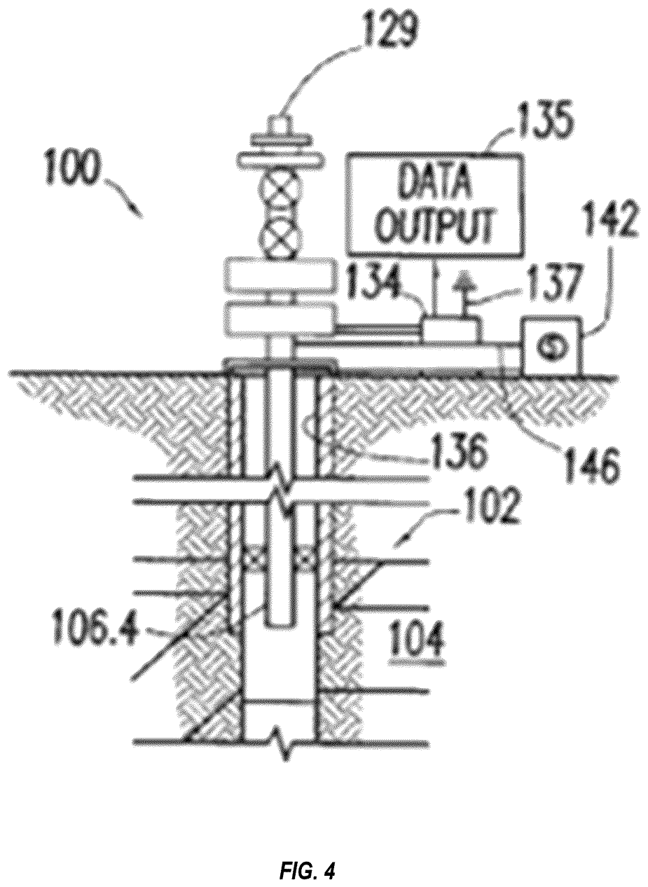

FIG. 4 depicts collection of seismic data during a production operation. As shown, the production operation may be performed by a production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) into production tool 106.4 in wellbore 136 and to surface facilities 142 via gathering network 146.

Sensors(S), such as gauges, may be positioned about oilfield 100 to collect data relating to various field operations. As shown, the sensor(S) may be positioned in production tool 106.4 or associated equipment, such as Christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

### Example Seismic Data Acquisition:

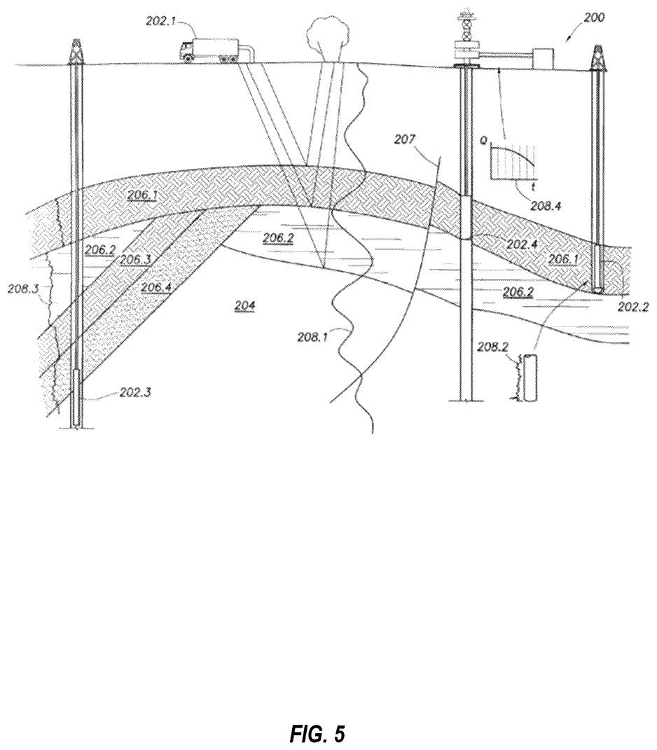

FIG. 5 depicts seismic data acquisition from an example oilfield 200. As shown, the FIG. 5 illustrates a schematic view, partially in cross-section of oilfield 200 having data acquisition tools 202.1, 202.2, 202.3 and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 1-4, respectively, or others not depicted. As shown, data acquisition tools 202.1-202.4 may generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively; however, it should be understood that data plots 208.1-208.3 may also be data plots that are updated in real time. The measurements may be analyzed to define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that typically provides a resistivity or other measurement of the formation at various depths.

A production decline curve or graph 208.4 is a dynamic data plot of the fluid flow rate over time. The production decline curve typically provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206.1-206.4. As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools may then be processed and/or evaluated. Seismic data displayed in static data plot 208.1 from data acquisition tool 202.1 may be used by a geophysicist to determine characteristics of the subterranean formations and features. The core data shown in static plot 208.2 and/or log data from well log 208.3 may be used by a geologist to determine various characteristics of the subterranean formation. The production data from graph 208.4 may be by a reservoir engineer to determine fluid flow reservoir characteristics. The data analyzed by the geologist, geophysicist, and the reservoir engineer may be analyzed using modeling techniques.

### Example Seismic Data Acquisition:

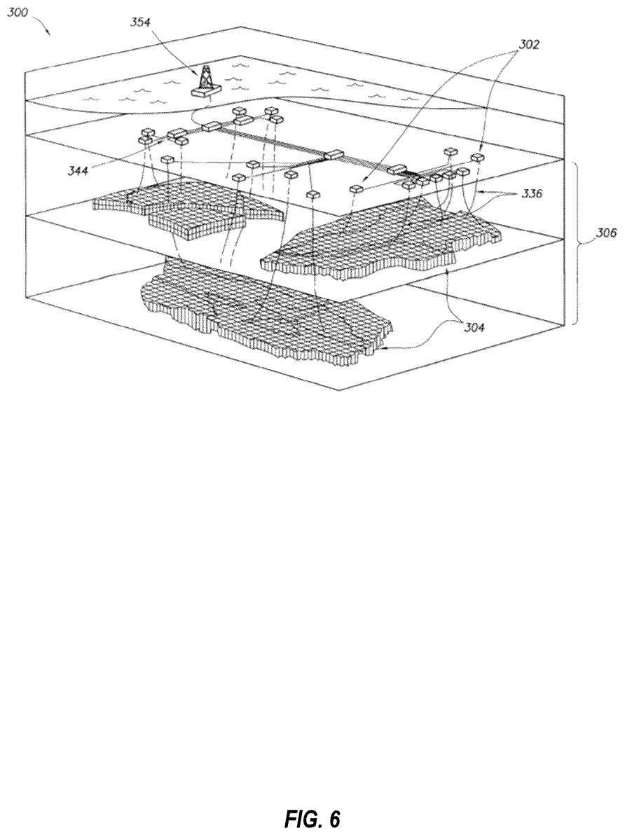

FIG. 6 depicts seismic data acquisition from an example oilfield 300. As shown, the oilfield 300 has a plurality of wellsites 302 operatively connected to a central processing facility 354. Part, or all, of the oilfield 300 may be on land and/or sea.

While a single oilfield 300 with a single processing facility 354 and a plurality of wellsites 302 is depicted in FIG. 6, any combination of one or more oilfields, one or more processing facilities and one or more wellsites may be present.

Each wellsite 302 has equipment that forms a wellbore 336 into the earth. The wellbores 336 extend through subterranean formations 306 including reservoirs 304. The reservoirs 304 contain fluids, such as hydrocarbons. The wellsites 302 draw fluid from the reservoirs 304 and pass the fluid to the processing facilities 354 via surface networks 344. The surface networks 344 have tubing and control mechanisms for controlling the flow of fluids from the wellsite to processing facility 354.

While FIGS. 1-6 illustrate example tools used to measure properties of an oilfield, it will be appreciated that the tools may be used in connection with non-oilfield operations, such as gas fields, mines, aquifers, storage or other subterranean facilities. Also, while certain data acquisition tools are depicted in FIGS. 1-6, it will be appreciated that various measurement tools capable of sensing parameters, such as seismic two-way travel time, density, resistivity, production rate, etc., of the subterranean formation and/or its geological formations may be used. Various sensors(S) may be located at various positions along the wellbore and/or the monitoring tools to collect and/or monitor the desired data. Other sources of data may also be provided from offsite locations.

### Example OBN Seismic Data Acquisition:

In some examples, seismic data may be collected via ocean bottom node (OBN) seismic data acquisition. OBN seismic data acquisition involves deploying autonomous recording units on the seafloor to capture seismic signals generated by acoustic sources. OBN acquisition may be employed for monitoring hydrocarbon production activities and exploring for new hydrocarbon reserves in marine environments. The placement of sensors directly on the seafloor may provide advantages over towed streamer acquisition methods, including the ability to record data with reduced noise from vessel motion and improved coupling between the sensors and the subsurface.

OBN acquisition may enable measuring long-offset refracted and diving waves that propagate through subsurface formations at angles that would not be captured by surface-towed acquisition systems. Long-offset data may provide information regarding velocity variations at greater depths within the subsurface, which may facilitate velocity model building and imaging improvements in geologically complex areas. Refracted waves that travel along formation boundaries and diving waves that curve through velocity gradients may carry information that complements the reflected wave data typically used in seismic imaging workflows.

The seismic data acquired using OBN systems may comprise OBN seismic data recorded by sensors positioned on the seafloor. OBN seismic data may exhibit characteristics that differ from data acquired using other marine seismic acquisition techniques due to the stationary nature of the recording sensors and the direct coupling with the seafloor sediments.

The seismic data acquired using OBN systems may comprise multi-component seismic data including at least one of horizontal component data, vertical component data, or pressure data. Multi-component recording may be achieved through the use of geophones or accelerometers oriented in three orthogonal directions combined with hydrophone sensors. Horizontal component data may include recordings from sensors oriented in two perpendicular horizontal directions, which may capture particle motion associated with both compressional and shear wave propagation. Vertical component data may include recordings from sensors oriented perpendicular to the seafloor surface, which may be sensitive to vertical particle motion associated with wave propagation. Pressure data may be recorded by hydrophone sensors that respond to pressure variations in the water column and seafloor sediments caused by passing seismic waves.

The combination of horizontal component data, vertical component data, and pressure data in multi-component OBN recordings may enable separation of upgoing and downgoing wavefields and may facilitate the analysis of both P-wave and S-wave propagation through subsurface formations. Multi-component data may support elastic full-waveform inversion applications that seek to recover both compressional and shear velocity models from recorded seismic observations. The availability of shear wave information from multi-component recordings may provide constraints on subsurface properties that cannot be obtained from pressure data alone.

### Example Full Waveform Inversion (FWI) of Seismic Data:

Seismic data may contain information across a range of frequencies, with different frequency bands providing different types of subsurface information. Low-frequency components of seismic data may carry information regarding large-scale geological structures and velocity variations within the subsurface. High-frequency components may provide finer resolution of smaller-scale features and stratigraphic details. The combination of low-frequency and high-frequency information may enable comprehensive characterization of subsurface geology.

Seismic data processing workflows may transform raw recorded data into interpretable images of subsurface structures. Processing steps may include noise attenuation, deconvolution, migration, and velocity analysis. The quality of the final seismic image may depend on the signal-to-noise ratio (SNR) of the recorded data and the accuracy of the velocity model used during processing.

Full-waveform inversion (FWI) is a technique for obtaining high-resolution seismic images and velocity models of the subsurface. FWI may employ gradient-based optimization methods to minimize misfits between observed seismic data and synthetic seismic data generated from a velocity model to find an optimal velocity model. The optimization process may iteratively adjust model parameters to reduce the difference between recorded field observations and forward-modeled synthetic waveforms computed using the current velocity model estimate.

The mathematical formulation of FWI may involve computing a misfit function that quantifies the difference between observed and synthetic data, calculating the gradient of the misfit function with respect to model parameters, and updating the model in a direction that reduces the misfit. The gradient computation may employ adjoint-state methods that propagate residual wavefields backward through the model to determine how changes in model parameters would affect the data misfit. Successive iterations of forward modeling, gradient computation, and model updating may progressively refine the velocity model toward a solution that better explains the observed seismic data.

FWI may be characterized as a nonconvex and nonlinear optimization problem and may become trapped in local minima when the starting model is accurate. The nonconvex nature of FWI arises from the oscillatory character of seismic waveforms, which may create multiple local minima in the misfit function landscape. The nonlinear relationship between velocity model parameters and recorded seismic waveforms may further complicate the optimization process. When the starting velocity model differs substantially from the true subsurface velocity distribution, FWI may become trapped in local minima rather than converging to the global minimum that represents the true velocity model.

### Cycle-Skipping:

Cycle-skipping issues may arise when initial velocity models are unavailable or inaccurate. Cycle-skipping is a phenomenon that may occur when FWI attempts to match observed and synthetic waveforms that are misaligned by more than half a wavelength. In such cases, the optimization algorithm may converge to an incorrect solution where synthetic events are matched to the wrong cycles of the observed data. The risk of cycle-skipping may increase when low-frequency content is absent from the seismic data, as low-frequency signals may provide the long-wavelength constraints that help guide the inversion toward the correct solution basin.

Various approaches have been developed to mitigate cycle-skipping in FWI applications. Robust misfit functions may be designed to reduce sensitivity to large phase differences between observed and synthetic data. However, such approaches may be unsuccessful when the velocity model exhibits substantial complexity and the initial model deviates significantly from the true subsurface velocity distribution. The availability of reliable low-frequency seismic signals may provide an alternative pathway to address cycle-skipping by enabling FWI to begin with longer-wavelength updates that establish the large-scale velocity structure before proceeding to higher-frequency refinements.

### Example Elastic Full-Waveform Inversion:

Elastic full-waveform inversion (EFWI) extends the FWI framework to recover both compressional (P-wave) and shear (S-wave) velocity models from multi-component seismic data. The nonlinearity of EFWI may be more severe than acoustic FWI due to the shorter wavelength of S-wave propagation relative to P-wave propagation at the same frequency. The increased nonlinearity of EFWI may heighten the dependence on accurate starting models and reliable low-frequency data to achieve convergence to geologically meaningful solutions.

### Challenge of Low-Frequency Components of Seismic Data:

Low-frequency signals are useful to high performing FWI gaining increasing interest with the availability of OBN acquisition. One challenge in seismic imaging is the absence of usable low-frequency signals as a result of noise recorded during acquisition, Low-frequency components of seismic data, such as frequency components below approximately 3.0 Hz, may be particularly susceptible to contamination by noise during seismic exploration activities. In ocean bottom environments, multiple noise sources may contribute to the degradation of low-frequency signal quality. Ocean currents interacting with seafloor-deployed sensors may generate low-frequency noise that obscures the seismic signals of interest. Coupling effects between the recording instruments and the seafloor sediments may introduce additional noise in the low-frequency band. Ambient seismic noise from distant earthquakes, ocean wave activity, and anthropogenic sources may further contaminate the low-frequency portion of the recorded data.

The absence of usable low-frequency signals may adversely affect the performance of full-waveform inversion applications. Low-frequency seismic content may provide constraints on large-scale velocity variations within the subsurface that guide the inversion toward geologically valid solutions. When low-frequency signals are masked by noise or otherwise unavailable, FWI may lack the long-wavelength information that establishes the broad velocity structure before higher-frequency refinements are applied. The missing low-frequency constraints may cause the inversion to converge to local minima in the misfit function rather than the global minimum representing the true velocity distribution.

In EFWI conducted on field acquisition data, the absence of a good initial velocity model may exacerbate cycle-skipping phenomena. When synthetic waveforms computed from an inaccurate starting model are misaligned with observed waveforms by more than half a wavelength, the optimization algorithm may match events to incorrect cycles of the recorded data. The resulting velocity updates may diverge from the true subsurface velocity structure rather than converging toward it. Low-frequency components below 3.0 Hz may be particularly challenging as these frequencies are frequently tainted by noise in real seismic exploration, and recovery may provide the long-wavelength constraints that mitigate cycle-skipping and improve FWI convergence behavior.

Performing FWI using enhanced seismic data may generate a velocity model of the subsurface formation. Enhanced seismic data having improved low-frequency content may provide the long-wavelength constraints that facilitate FWI convergence and reduce the risk of cycle-skipping artifacts. The velocity model generated through FWI using enhanced seismic data may exhibit improved accuracy in regions where the original seismic data lacked sufficient low-frequency signal quality to constrain the inversion. The enhanced low-frequency content may enable FWI to proceed from lower starting frequencies, which may expand the basin of attraction around the true velocity model and improve the likelihood of convergence to a geologically valid solution.

Deep learning models have been use to extrapolate absent low frequency information by inferring highly non-linear mappings between low frequency signals and high-frequency counterparts. However, challenges with the use of deep learning models have included few utilizations of multi-component data and scarcity of clean low frequency data. Self-supervised learning (SSL) addresses scarcity by generating pseudo-labels using existing seismic data, enabling domain-specific models building. SSL can be used to apply different sampling intervals and frequency ranges to construct training and testing datasets.

Transformers may be used to attend to long-distance dependencies and improve model performance. However, complex transformers impose strenuous computation requirements on model trainings. Further, some transforms have difficulty distinguishing real signal energy from background noise, especially in OBN surveys for which low-frequency data may exhibit low SNR.

Accordingly, techniques for seismic data enhancement and, in particular, enhancement of low-frequency seismic data are desirable.

### Example Self-Supervised Learning with Cross-Training Between Convolutional Neural Network (CNN) and Transformers for Low-Frequency Seismic Data Enhancement

Aspects of the present disclosure provide apparatuses, methods, processing systems, and computer-readable mediums for enhancing low-frequency signals in seismic data using self-supervised learning (SSL) with cross-training between convolutional neural networks and transformer neural networks. According to certain aspects, the SSL cross-training may be used to train the transformer neural network to enhance low-frequency seismic data.

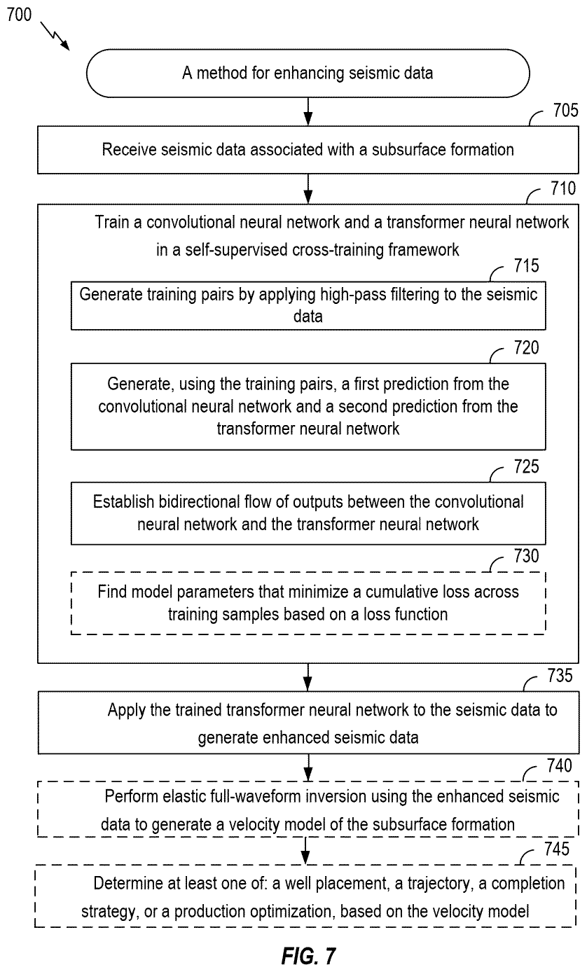

FIG. 7 shows a method 700 for enhancing seismic data. The method 700 for enhancing low-frequency signals in seismic data may address the challenges associated with noise-contaminated low-frequency content in seismic recordings. The method 700 may employ machine learning techniques that leverage the complementary strengths of different neural network architectures to recover and enhance low-frequency information that would otherwise be unusable for downstream applications such as full-waveform inversion.

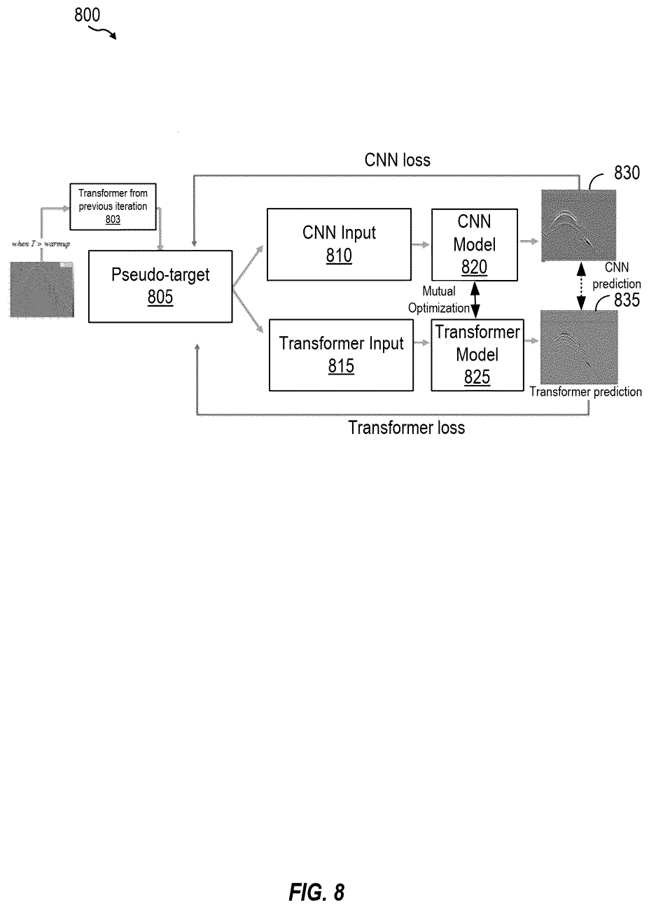

FIG. 8 depicts a self-supervised cross-training framework 800 for a convolutional neural network (CNN) and transformer neural network to enhance seismic data. Aspects of the method 700 may described with respect to the self-supervised cross-training framework 800.

### Seismic Data Collection:

As shown in FIG. 7, method 700 begins at operation 705 with receiving seismic data associated with a subsurface formation. The seismic data may be received through various acquisition technologies, including one or more ocean bottom node (OBN) seismic sensors that record multi-component seismic signals on the seafloor. In some aspects, the seismic data includes low-frequency components, such as low-frequency signals below 3.0 Hz. In some aspects, the seismic data comprises noisy data. The noisy data may include noise from at least one of: ocean current, instrument coupling effects, and ambient seismic sources. As shown in FIG. 8, the self-supervised cross-training framework 800 obtains observed seismic data 805.

### Self-Supervised Cross-Training of CNN and Transformer Neural Networks:

As shown in FIG. 7, method 700 then proceeds to operation 710 with training a convolutional neural network (CNN) and a transformer neural network in a self-supervised cross-training framework.

The cross-training may establish mutual optimization and constraint relationships between the CNN and the transformer neural network. The combination of CNN and transformer neural network architectures within the self-supervised cross-training framework may leverage the respective strengths of each architecture type. With SSL targeting the unavailability of usable low-frequency targets from field data in conventional training, both the CNN and transformer model structures are reinforced to train under the hybrid loss function with extra emphasis on low frequency extrapolations in a mutual optimizing yet constraining fashion.

The self-supervised cross-training scheme may iteratively train the model to improve predictions from gradually refined pseudo-targets generated by models from the previous stage.

### SSL:

Self-supervised learning refers to a machine learning paradigm in which a model learns representations from unlabeled seismic data by generating supervisory signals, or training targets, from the seismic data itself rather than relying on externally provided labels. In self-supervised learning, the training process creates pseudo-labels or auxiliary tasks derived from the structure or properties inherent in the input data, enabling the model to learn meaningful features without manual annotation and, to learn mappings between high-frequency and low-frequency signal characteristics without requiring clean low-frequency reference data.

Self-supervised learning may be employed when ground truth targets are unavailable or of insufficient quality, as is the case with noise-contaminated low-frequency seismic signals. Self-supervised learning may be particularly advantageous in domains where labeled training data is scarce, expensive to obtain, or fundamentally unavailable due to the nature of the problem being addressed.

According to certain aspects, the SSL is used to cross-train a visual transformer neural network (ViT).

### CNN:

In some aspects, the CNN extracts features from the seismic data. A CNN is a class of deep learning architecture that processes input data through layers of learnable convolutional filters. Each convolutional layer applies kernels across the input to extract features at progressively higher levels of abstraction, with early layers typically capturing low-level patterns such as edges and textures while deeper layers capture more complex semantic features. The convolutional neural network may excel at extracting local features from seismic data through the application of convolutional kernels that operate over spatially limited regions of the input data.

In some aspects, the convolutional neural network is a U-Net. A U-Net architecture is a CNN that employs an encoder-decoder structure with skip connections. The encoder portion progressively downsamples the input through successive convolutional and pooling operations to capture contextual information at multiple scales. The decoder portion upsamples the encoded representation back to the original resolution through transposed convolutions or upsampling operations. Skip connections bridge corresponding layers of the encoder and decoder, concatenating feature maps from the encoding path with those in the decoding path to preserve fine-grained spatial information that would otherwise be lost during downsampling. This architecture enables precise localization while maintaining the ability to capture broad contextual features.

### Transformer Neural Network:

In some aspects, the transformer neural network computes attention for the extracted features. Transformer neural networks represent a class of deep learning architectures that employ self-attention mechanisms to model relationships between elements in sequential or spatial data. Unlike convolutional neural networks that operate through local receptive fields, transformer architectures compute attention weights that relate each position in the input to all other positions, enabling the capture of long-range dependencies. The attention mechanism computes query, key, and value representations from input features and produces output features as weighted combinations of values, where the weights are determined by compatibility between queries and keys. Transformer architectures have demonstrated effectiveness across diverse domains including natural language processing, computer vision, and signal processing applications. The transformer neural network may capture long-distance dependencies within the seismic data through attention mechanisms that relate information across extended spatial and temporal ranges.

In some aspects, the transformer neural network is a Swin transformer. The Swin Transformer architecture introduces a hierarchical structure with shifted window attention mechanisms that address computational efficiency limitations of standard transformer architectures. The Swin Transformer partitions input features into non-overlapping local windows and computes self-attention within each window, reducing computational complexity from quadratic to linear with respect to input size. Shifted window partitioning in alternating layers enables cross-window connections that allow information flow between adjacent windows. The hierarchical structure produces multi-scale feature representations through patch merging operations that progressively reduce spatial resolution while increasing feature dimensionality.

In some aspects, the transformer neural network is a neighborhood attention transformer. The neighborhood attention transformer architecture restricts attention computations to local neighborhoods surrounding each position in the input. Rather than computing attention across the entire input or within fixed windows, neighborhood attention defines a receptive field around each query position and computes attention only with keys and values within that neighborhood. This approach maintains the ability to capture relevant local dependencies while reducing computational requirements compared to global attention. The neighborhood attention mechanism provides flexibility in defining receptive field sizes and shapes to match the characteristics of different data types and applications.

In some aspects, the transformer neural network is a sparse attention transformer. The sparse attention transformer architecture selectively computes attention between a subset of position pairs rather than all possible pairs. Sparse attention mechanisms identify the most informative relationships within the input data and focus computational resources on those relationships while disregarding less relevant connections. Various sparsity patterns may be employed, including learned sparsity that adapts to data characteristics during training. Sparse attention transformers may achieve improved computational efficiency and enhanced prediction robustness by filtering out irrelevant features that could otherwise introduce noise into the attention computations.

### Self-Supervised Cross-Training of CCN and Transformer Neural Network:

The training process may include a warmup stage and an iterative data refinement stage. During the warmup stage, a learning target comprises original observed field data. During the iterative data refinement stage, the learning target comprises pseudo-data generated by models from a previous iteration. This two-stage approach may address the challenge that ground truth low-frequency signals are often masked by noise and therefore unsuitable as direct training targets.

Referring again to FIG. 7, as shown, the self-supervised cross-training at operation 710 includes a warm-up training stage. During the initial warmup stage, model parameters and weights may be trained using observed seismic data as a learning target. The warm-up training stage may include training the CNN and the transformer neural network using band-limited seismic training data having higher-frequency content than a target low-frequency band. During the warmup stage, the CNN and the transformer neural network may learn to translate higher frequency signals to lower frequency signals before progressively decreasing a lower bound of the cutoff frequencies toward a target low-frequency band. This progressive approach allows the neural networks to first learn general frequency translation relationships in frequency bands where signal quality remains high, before attempting to extrapolate into noisier low-frequency regions. The warmup stage thus serves to stabilize model parameters and establish baseline frequency translation capabilities.

According to certain aspects, the self-supervised cross-training may be expressed as:

$$θ = {argmin}_{θ} {\sum }_{i = 1}^{N} L ( {f}_{{θ}_{S L}} ( {x}_{i} , {y}_{i} ) )$$

where θ represents the model parameters, L represents a loss function, f_{θ}_{_{SL}} represents the neural network function parameterized by θ, xᵢ represents input data samples, and yᵢ represents target data samples. The optimization process may seek to find parameter values that minimize the cumulative loss across all training samples.

In some aspects, the self-supervised cross-training at operation 710 includes an iterative data refinement stage. During the iterative data refinement stage, the learning target transitions from the original observed field data to pseudo-data generated by models from a previous iteration. This transition allows the training process to iteratively refine predictions using progressively cleaner pseudo-targets. Each iteration may produce less-noisy pseudo-data compared to the original observed data, enabling the networks to learn finer details of the low-frequency signal structure. The iterative data refinement stage continues the progressive decrease of the lower bound of cutoff frequencies, extending the frequency extrapolation capability toward the target low-frequency band. As shown in FIG. 8, for a current iteration T, the self-supervised cross-training framework 800 uses the transformer 803 from the previous iteration (T−1).

According to certain aspects, the self-supervised cross-training at operation 710 includes, at operation 715, generating training pairs by applying high-pass filtering to the seismic data. The high-pass filtering may be performed with cutoff frequencies sampled from predefined frequency ranges. The high-pass filtering operation may remove low-frequency content from the seismic data to create input samples that the neural networks learn to map back to full-bandwidth targets.

The learning target during the IDR stage is replaced with less-noisy pseudo-data, f_{θ}_{_{T-1}}(γ_{obs}), generated by models from the previous iteration. For both the warmup stage and the IDR stage, the training pairs may be composed as {HP(yᵢ), yᵢ} where HP is the high-pass filter. The target data samples may be given by:

$${y}_{i} = \{ \begin{matrix}{y}_{o b s} , & T ∈ warmup \\ {f}_{{θ}_{T - 1}} ( {y}_{o b s} ) , & T ∈ IDR\end{matrix}$$

For each iteration T, given target yᵢ, training pairs

$${f}_{θ}^{c} ( \cdot )$$

may be constructed for the CNN as {HP_{c}(yᵢ), yᵢ} and training pairs

$${f}_{θ}^{t} ( \cdot )$$

may be constructed for the transformer neural network as {HPₜ(yᵢ), yᵢ}.

In some aspects, applying the high-pass filtering at operation 715 includes generating a first training input for the CNN by applying a first high-pass filter to the observed seismic data, or pseudo-training target enhanced seismic data from a previous iteration, using a first cutoff frequency and generating a second training input for the transformer neural network by applying a second high-pass filter to the seismic data using a second cutoff frequency different from the first cutoff frequency. The first cutoff frequency and the second cutoff frequency may be independently sampled from the predefined frequency ranges to introduce perturbations in input data distributions. The independent sampling of cutoff frequencies may create diversity in the training inputs provided to each neural network, which may improve the robustness of the learned mappings and prevent the networks from converging to identical solutions.

As shown in FIG. 8, the self-supervised cross-training framework 800 obtains seismic data 805. The seismic data may be pseudo-training target data. In some aspects, the transformer from the previous iteration 803 is used to enhance the low-frequency components of observed seismic data to generate the pseudo-training target 805. The pseudo-training target 805 may then be used to calculate the CNN loss and transformer loss.

As shown, a first high-pass filter (not shown) may be applied to the seismic data 805 with a first cutoff frequency to generate a first filtered input 810 for the CNN 820 and a second high-pass filter (not shown) may be applied to the observed seismic data 805 with a second cutoff frequency different from the first cutoff frequency to generate a second filtered input 815 for the transformer neural network 825.

In some aspects, a lower bound of the first cutoff frequency and the second cutoff frequency are gradually decreased in each iteration of the iterative data refinement stage to ensure effective frequency extrapolation, model stability, and robustness.

According to certain aspects, the self-supervised cross-training at operation 710 includes, at operation 720, generating a first prediction from the convolutional neural network and a second prediction from the transformer neural network using the training pairs. In some aspects, generating the first prediction from the CNN and the second prediction from the transformer neural network at operation 720 includes, during the iterative data refinement stage, independently sampling the first cutoff frequency and the second cutoff frequency from predefined frequency ranges to introduce perturbations between inputs to the convolutional neural network and the transformer neural network, generating the first prediction from the convolutional neural network based on the first training input, and generating the second prediction from the transformer neural network based on the second training input.

According to certain aspects, the self-supervised cross-training at operation 710 includes, at operation 725, establishing bidirectional flow of outputs between the convolutional neural network and the transformer neural network.

The self-supervised cross-training may include generating pseudo-labels through the iterative refinement processes that progressively improve the quality of training targets as the neural networks learn to map high-frequency content to low-frequency content. In some aspects, establishing the bidirectional flow of the outputs between the CNN and the transformer neural network at operation 725 includes, during the iterative data refinement stage, generating a first pseudo-label for the CNN using the second prediction from the transformer neural network, and generating a second pseudo-label for the transformer neural network using the first prediction from the CNN. The cross-training between the CNN and the transformer neural network may improve the quality of the generated pseudo-labels.

The first prediction may represent the CNN's estimate of the full-bandwidth seismic data given the first filtered input. In some aspects, the prediction set [symbol] may be generated by the CNN as:

$$\text{?} = {f}_{θ}^{c} ( {x}_{i}^{c} + {ϵ}_{c} ) ,$$

$$where$$

$${x}_{i}^{c} = {HP}_{c} ( {y}_{i} )$$

The second prediction may represent the transformer neural network's estimate of the full-bandwidth seismic data given the second filtered input. In some aspects, the second prediction set [symbol] may be generated by the transformer neural network as:

$$\text{?} = {f}_{θ}^{t} ( {x}_{i}^{t} + {ϵ}_{t} )$$

$$where$$

$${x}_{i}^{t} = {HP}_{t} ( {y}_{i} ) ,$$

where ∈_{*} denotes additional Gaussian noise introduced during training to improve model robustness.

A pseudo-label set may be generated for the CNN as

$${ps}_{i}^{c} = {f}_{θ}^{t} ( {x}_{i}^{c} )$$

and a pseudo-label set may be generated for the transformer neural network as

$${ps}_{i}^{t} = {f}_{θ}^{c} ( {x}_{i}^{t} ) .$$

The bidirectional information flow may enable each neural network to benefit from the learned representations of the other neural network. The CNN may receive guidance from the transformer neural network's ability to capture long-distance dependencies, while the transformer neural network may receive guidance from the convolutional neural network's ability to extract local features. The mutual exchange of pseudo-labels may stabilize the training process and improve the quality of the learned mappings.

According to certain aspects, the self-supervised cross-training at operation 710 includes, at operation 730, finding model parameters that minimize a cumulative loss across training samples based on a loss function.

The method 700 may include optimizing parameters of the CNN and the transformer neural network that minimize the cumulative loss based on the first pseudo-label and the second pseudo-label. In some aspects, the reconstruction loss involves a sum of (i) a first loss between the first prediction and the first pseudo-label and (ii) a second loss between the second prediction and the second pseudo-label. The reconstruction loss L_{rec} may be given by the first and second prediction sets and the pseudo-label sets:

$${L}_{rec} = L ( \text{?} , {ps}_{i}^{c} ) + L ( \text{?} , {ps}_{i}^{t} )$$

In some aspects, the loss function is a self-supervised hybrid loss function based on an amplitude loss, a frequency loss, and a reconstruction loss based on the first pseudo-label and the second pseudo-label.

In some aspects, method 700 further includes adding Gaussian noise during the training, wherein the Gaussian noise is sampled from a normal distribution with zero mean. The reconstruction loss may be introduced to overall loss Lₜₒₜₐₗ by a time-dependent Gaussian warmup factor β(t), where:

$$β ( t ) = 0.1 \cdot {e}^{- 5 {( 1 - \frac{{T}_{i}}{{T}_{total}} )}^{2}} ,$$

where Tᵢ represents the current iteration number and Tₜₒₜₐₗ represents the total number of training iterations. The time-dependent Gaussian warmup factor may start at a low value during early training iterations and gradually increases toward 0.1 as training progresses toward completion. The gradual increase in the reconstruction loss weight allows the models to first establish stable individual predictions before the cross-training constraint becomes more influential.

The total loss function may be expressed as:

$${L}_{total} = {L}_{amp} + α \cdot {L}_{freq} + β \cdot {L}_{rec} ,$$

where Lₐₘₚ represents the amplitude loss component, L_{freq} represents the frequency loss component, and L_{rec} represents the reconstruction loss component. The amplitude loss and frequency loss components for each network may be defined as:

$${L}_{*} = {L}_{*}^{c} ( \text{?} , {y}_{i} ) + {L}_{*}^{t} ( \text{?} , {y}_{i} ) ,$$

$$and$$

$$* ∈ ( amp , freq ) ,$$

where the superscript c denotes the CNN contribution and the superscript t denotes the transformer neural network contributions.

In some aspects, the loss function coefficients α and β are tunable to adjust the relative importance of frequency loss and reconstruction loss. Adjusting the alpha and beta coefficients allows the training process to be adapted for different datasets, geological regions, or signal-to-noise ratio conditions encountered in seismic data acquisition.

As shown in FIG. 8, the self-supervised cross-training framework 800 feeds back the loss from the CNN prediction 830 and the loss from the transformer neural network prediction 835. The CNN prediction output 830 and transformer prediction output 835 are used for cross-training. Each model uses the prediction of the other model as a supervisory signal, thereby enabling bidirectional information exchange. This mutual supervision enforces consistency between locally extracted features from the CNN model and long-range dependency representations learned by the transformer model.

In some aspects, gradient flow between the predictions and the pseudo-labels may be stopped during loss computation to ensure training convergence. Stopping the gradient flow may prevent the CCN and transformer neural networks from becoming overly focused on matching the pseudo-labels at the expense of learning the underlying mapping between high-frequency and low-frequency signal characteristics.

In some aspects, the iterative refinement approach of method 700 may include use of feedback loops executed on an algorithmic basis, such as at a computing device, and/or through manual control by a user who may make determinations regarding whether a given step, action, template, or model has become sufficiently accurate.

### Seismic Data Enhancement Using Inference by SSL Cross-Trained Transformer Neural Network:

Following completion of the self-supervised cross-training training, the trained neural networks may be deployed for inference to process seismic data and generate enhanced seismic data having improved low-frequency. The trained transformer neural network may be employed for inference due to the ability of transformer architectures to capture long-distance dependencies that may be relevant for generating coherent low-frequency events across extended spatial and temporal ranges.

Referring again to FIG. 7, as shown, method 700 proceeds to operation 735 with applying the trained transformer neural network to the seismic data to generate enhanced seismic data. During inference, the trained transformer neural network may receive high-pass filtered seismic data as input and generate output seismic data in which low-frequency signals have been enhanced and extrapolated. The inference process may apply the learned mapping between high-frequency and low-frequency signal characteristics to produce enhanced seismic data suitable for downstream applications such as FWI.

The enhanced seismic data may have improved low-frequency components, in which low-frequency signals have been denoised and extrapolated. The enhanced seismic data may exhibit improved signal-to-noise ratio (SNR) in the low-frequency band compared to the original seismic data acquired at the operation 705.

FWI with Enhanced Seismic Data to Generate Velocity Model:

As shown in FIG. 7, in some aspects, method 700 includes, at operation 740, performing elastic full-waveform inversion using the enhanced seismic data to generate a velocity model of the subsurface formation. The enhanced seismic data may contain low-frequency components suitable for use in the FWI, where the original noise-contaminated low-frequency signals may have been inadequate. The enhanced low-frequency content may enable the FWI to proceed from lower starting frequencies, which may reduce cycle-skipping artifacts and improve convergence to geologically valid velocity models.

### Wellbore Operations Using Velocity Model:

According to certain aspects, actions may be taken based on the velocity model for reservoir characterization and hydrocarbon exploration. The velocity model may be integrated with other geological and geophysical data to develop subsurface models that describe reservoir geometry, rock properties, and fluid distributions.

As shown in FIG. 7, in some aspects, method 700 includes at operation 745, determining at least one of: a well placement, a trajectory, a completion strategy, or a production optimization, based on the velocity model.

Well placement decisions may be informed by the velocity model, as accurate velocity information may improve the identification of drilling targets and the prediction of subsurface conditions along proposed well trajectories.

Completion strategies may be designed based on reservoir characterization results that incorporate the improved velocity model, enabling optimization of perforation intervals and stimulation treatments to maximize hydrocarbon recovery.

Production optimization activities may employ the velocity model to guide reservoir management decisions. The velocity model may support time-lapse seismic monitoring applications that track changes in reservoir conditions during production operations. Enhanced oil recovery planning may benefit from improved subsurface characterization enabled by the accurate velocity model, as injection strategies and sweep efficiency predictions may depend on reliable knowledge of subsurface velocity and property distributions

In one aspect, method 700, or any aspect related to it, may be performed by an apparatus, such as system 1000 of FIG. 10, which includes various components operable, configured, or adapted to perform the method 700. System 1000 is described below in further detail.

Note that FIG. 7 is just one example of a method, and other methods including fewer, additional, or alternative steps are possible consistent with this disclosure.

### Advantages

In some aspects, the SSL cross-training CNN and transformer cross training scheme, may overcome the problems of previous seismic data collection systems described herein and other problems.

The SSL cross-trained CCN and transformer neural network may be used for seismic data low frequency enhancement by taking advantage of both CNN and transformer architectures to enable improved FWI and cycle-skipping. The SSL cross-training effectively remove noise and extrapolates low frequency events from high frequency counterparts by learning the highly non-linear mapping.

Further, the SSL cross-training may be applied to seismic data from various geological settings and acquisition configurations, allowing the neural networks to adapt to the specific noise characteristics and signal properties of the local data and configuration. The trained neural networks may generalize across different portions of the survey area and may be fine-tuned for application to seismic data from other geological regions through additional training on limited amounts of data from the new target area

### Example System for Enhanced Seismic Data Processing

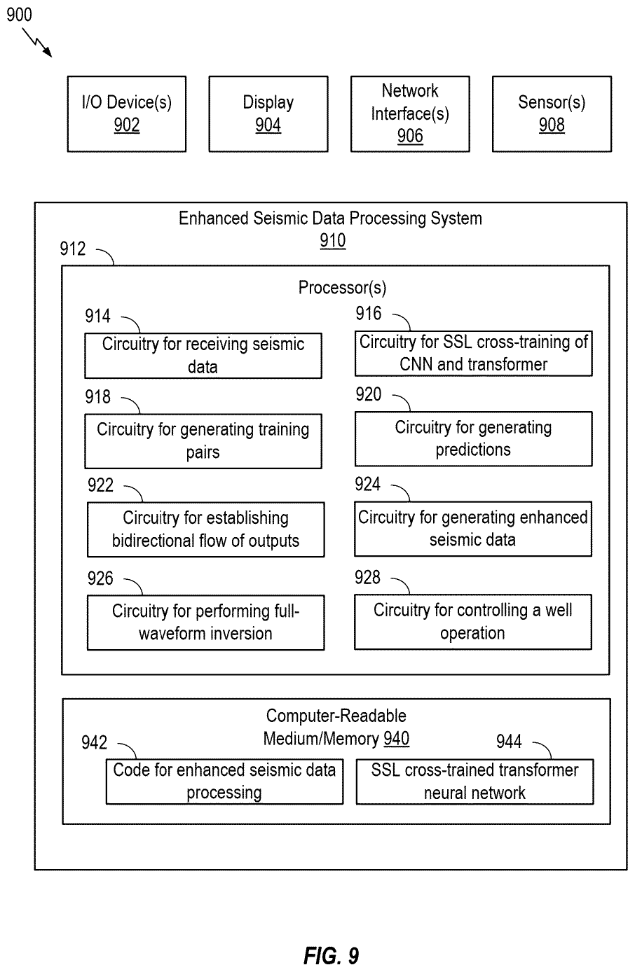

FIG. 9 depicts an example system 900 for enhanced seismic data processing.

The system 900 may be implemented as a single device or, in some aspects, components of system 900 may be implemented across multiple physical devices. In some aspects, the components of system 900 may be located at a well, remotely from the well, and/or distributed across locations at the well and remote locations.

The system 900 includes enhanced seismic data processing system 910. The enhanced seismic data processing system 910 includes processor(s) 912, which may be coupled to network interface(s) 906. The network interface(s) 906 may be configured to transmit and receive signals for the system 900 wirelessly, via a wired connection, via mud pulse telemetry, or other suitable techniques. The network interface 906 may be used for inter-communication between components within the system 900 and/or for communication with other devices or systems over a network.

The processor(s) 912 may be coupled to a computer-readable medium/memory 940 via a bus or may communicate with the computer-readable medium/memory 940 via a wired or wireless connection over a network. In certain aspects, the computer-readable medium/memory 940 is configured to store instructions (e.g., computer-executable code 942) that when executed by the one or more processors, cause the one or more processors to perform the method 700 described with respect to FIG. 7, or any aspect related to it. Note that reference to a processor performing a function of system 900 may include one or more processors performing that function of system 900. Computer-readable medium/memory 940 may further store a SSL cross-trained transformer neural network 944.

The processor(s) 912 includes circuitry configured to implement (e.g., execute) the aspects described herein for enhanced seismic data processors. The circuitry may include circuitry for receiving seismic data 914, circuitry for SSL cross-training of CNN and transformer 916, circuitry for generating training pairs 918, circuitry for generating predictions 920, circuitry for establishing bidirectional flow of outputs 922, circuitry for generating enhanced seismic data 924, circuitry for performing full-waveform inversion 926, and circuitry for controlling a well operation 928. Processing with circuitry 914-928 may cause the system 900 to perform the method 700 described with respect to FIG. 7 or any aspect related to it.

The system 900 may include one or more input output (I/O) devices 902. The one or more I/O devices 902 may include a user interface to accept inputs from a user. In some aspects, the user interface is a graphical user interface (GUI). In some aspects, the GUI accepts touch screen inputs from the user. In some aspects, the I/O devices 902 include keyboards, displays, mouse devices, pen inputs, microphones, etc., that connect to the system 900.

The system 900 may include a display 904 configured to display enhanced seismic data, FWI results, or other data discussed herein.

The system 900 may include one or more sensors 908. The one or more sensors 908 may be configured to collect seismic measurements for enhanced seismic data processing.

### Example Clauses

Implementation examples are described in the following numbered clauses:

Clause 1: A method for enhancing seismic data, comprising: receiving seismic data associated with a subsurface formation; training a convolutional neural network and a transformer neural network in a self-supervised cross-training framework, wherein the training includes: generating training pairs by applying high-pass filtering to the seismic data; generating, using the training pairs, a first prediction from the convolutional neural network and a second prediction from the transformer neural network; and establishing bidirectional flow of outputs between the convolutional neural network and the transformer neural network; and applying the trained transformer neural network to the seismic data to generate enhanced seismic data.

Clause 2: The method of Clause 1, wherein the seismic data is received from one or more ocean bottom seismic sensors.

Clause 3: The method of any combination of Clauses 1-2, wherein the seismic data comprises low-frequency signals below 3.0 Hz.

Clause 4: The method of any combination of Clauses 1-3, wherein the seismic data comprises noisy data.

Clause 5: The method of any combination of Clauses 1-4, wherein the noisy data includes noise from at least one of: ocean current, instrument coupling effects, and ambient seismic sources.

Clause 6: The method of any combination of Clauses 1-5, wherein the convolution neural network extracts features from the seismic data.

Clause 7: The method of any combination of Clauses 1-6, wherein the convolutional neural network comprises a U-Net architecture.

Clause 8: The method of any combination of Clauses 6-7, wherein the transformer neural network computes attention for the extracted features.

Clause 9: The method of any combination of Clauses 6-8, wherein the transformer neural network comprises at least one of: a Swin transformer, a neighborhood attention transformer, or a sparse attention transformer.

Clause 10: The method of any combination of Clauses 1-9, wherein training the convolutional neural network and the transformer neural network comprises a warm-up training stage, and wherein the warm-up training stage comprises training the convolutional neural network and the transformer neural network using band-limited seismic training data having higher-frequency content than a target low-frequency band.

Clause 11: The method of any combination of Clauses 1-10, wherein training the convolutional neural network and the transformer neural network comprises finding model parameters that minimize a cumulative loss across training samples based on a loss function.

Clause 12: The method of any combination of Clauses 1-11, wherein training the convolutional neural network and the transformer neural network comprises an iterative data refinement stage including, in a current iteration, training the convolutional neural network and the transformer network using pseudo-labels generated by the convolutional neural network and the transformer neural network from a previous iteration.

Clause 13: The method of any combination of Clauses 11-12, wherein generating the training pairs includes, during the iterative data refinement stage: generating a first training input for the convolutional neural network by applying a first high-pass filter to the seismic data using a first cutoff frequency; and generating a second training input for the transformer neural network by applying a second high-pass filter to the seismic data using a second cutoff frequency different from the first cutoff frequency.

Clause 14: The method of any combination of Clauses 11-13, wherein the first cutoff frequency and the second cutoff frequency are adjusted in each iteration of the iterative data refinement stage.

Clause 15: The method of any combination of Clauses 13-14, wherein generating, using the training pairs, the first prediction from the convolutional neural network and the second prediction from the transformer neural network includes, during the iterative data refinement stage: independently sampling the first cutoff frequency and the second cutoff frequency from predefined frequency ranges to introduce perturbations between inputs to the convolutional neural network and the transformer neural network; generating the first prediction from the convolutional neural network based on the first training input; and generating the second prediction from the transformer neural network based on the second training input.

Clause 16: The method of any combination of Clauses 13-15, wherein establishing the bidirectional flow of the outputs between the convolutional neural network and the transformer neural network includes, during the iterative data refinement stage: generating a first pseudo-label for the convolutional neural network using the second prediction from the transformer neural network; and generating a second pseudo-label for the transformer neural network using the first prediction from the convolutional neural network.

Clause 17: The method of any combination of Clauses 11-16, wherein training a convolutional neural network and a transformer neural network comprises optimizing parameters of the convolutional neural network and the transformer neural network that minimize the cumulative loss based on the first pseudo-label and the second pseudo-label.

Clause 18: The method of any combination of Clauses 11-17, wherein the loss function comprises a self-supervised hybrid loss function based on an amplitude loss, a frequency loss, and a reconstruction loss based on the first pseudo-label and the second pseudo-label.

Clause 19: The method of any combination of Clauses 16-18, wherein the reconstruction loss comprises a sum of (i) a first loss between the first prediction and the first pseudo-label and (ii) a second loss between the second prediction and the second pseudo-label.

Clause 20: The method of any combination of Clauses 1-19, further comprising adding Gaussian noise during the training, wherein the Gaussian noise is sampled from a normal distribution with zero mean.

Clause 21: The method of any combination of Clauses 1-20, further comprising performing elastic full-waveform inversion using the enhanced seismic data to generate a velocity model of the subsurface formation.

Clause 22: The method of any combination of Clauses 21, further comprising making at least one of: a well placement determination, a trajectory determination, a completion strategy, or a production optimization decision, based on the velocity model.

Clause 23: An apparatus, comprising: a memory comprising executable instructions; and one or more processors configured to execute the executable instructions and cause the apparatus to perform a method in accordance with any one of Clauses 1-22.

Clause 24: An apparatus, comprising means for performing a method in accordance with any one of Clauses 1-22.

Clause 25: A non-transitory computer-readable medium comprising executable instructions that, when executed by one or more processors of an apparatus, cause the apparatus to perform a method in accordance with any one of Clauses 1-22.

Clause 26: A computer program product embodied on a computer-readable storage medium comprising code for performing a method in accordance with any one of Clauses 1-22.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, “a processor,” “at least one processor,” or “one or more processors” generally refer to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refer to a single memory configured to store data and/or instructions or multiple memories configured to collectively store data and/or instructions.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

It will also be understood that, although the terms first, second, etc., may be used herein to describe various elements, these elements should not be limited by these terms. These terms are used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

As used herein, the term “if” may be construed to mean “when” or “upon” or “in response to determining” or “in response to detecting,” depending on the context.

Those with skill in the art will appreciate that while some terms in this disclosure may refer to absolutes, e.g., all of the components of a wavefield, all source receiver traces, each of a plurality of objects, etc., the methods and techniques disclosed herein may also be performed on fewer than all of a given thing, e.g., performed on one or more components and/or performed on one or more source receiver traces. Accordingly, in instances in the disclosure where an absolute is used, the disclosure may also be interpreted to be referring to a subset.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for enhancing seismic data, comprising:
receiving seismic data associated with a subsurface formation;
training a convolutional neural network and a transformer neural network in a self-supervised cross-training framework, wherein the training includes:
generating training pairs by applying high-pass filtering to the seismic data;
generating, using the training pairs, a first prediction from the convolutional neural network and a second prediction from the transformer neural network; and
establishing bidirectional flow of outputs between the convolutional neural network and the transformer neural network; and
applying the trained transformer neural network to the seismic data to generate enhanced seismic data.

2. The method of claim 1, wherein:
the seismic data is received from one or more ocean bottom seismic sensors;
the seismic data comprises low-frequency signals below 3.0 Hz; and
the seismic data comprises noise from at least one of: ocean current, instrument coupling effects, and ambient seismic sources.

3. The method of claim 1, wherein the convolution neural network extracts features from the seismic data.

4. The method of claim 3, wherein the convolutional neural network comprises a U-Net architecture.

5. The method of claim 4, wherein the transformer neural network computes attention for the extracted features.

6. The method of claim 1, wherein training the convolutional neural network and the transformer neural network comprises a warm-up training stage, and wherein the warm-up training stage comprises training the convolutional neural network and the transformer neural network using band-limited seismic training data having higher-frequency content than a target low-frequency band.

7. The method of claim 1, wherein training the convolutional neural network and the transformer neural network comprises finding model parameters that minimize a cumulative loss across training samples based on a loss function.

8. The method of claim 7, wherein training the convolutional neural network and the transformer neural network comprises an iterative data refinement stage including, in a current iteration, training the convolutional neural network and the transformer network using pseudo-labels generated by the convolutional neural network and the transformer neural network from a previous iteration.

9. The method of claim 8, wherein generating the training pairs includes, during the iterative data refinement stage:
generating a first training input for the convolutional neural network by applying a first high-pass filter to the seismic data using a first cutoff frequency; and
generating a second training input for the transformer neural network by applying a second high-pass filter to the seismic data using a second cutoff frequency different from the first cutoff frequency.

10. The method of claim 9, wherein the first cutoff frequency and the second cutoff frequency are adjusted in each iteration of the iterative data refinement stage.

11. The method of claim 9, wherein generating, using the training pairs, the first prediction from the convolutional neural network and the second prediction from the transformer neural network includes, during the iterative data refinement stage:
independently sampling the first cutoff frequency and the second cutoff frequency from predefined frequency ranges to introduce perturbations between inputs to the convolutional neural network and the transformer neural network;
generating the first prediction from the convolutional neural network based on the first training input; and
generating the second prediction from the transformer neural network based on the second training input.

12. The method of claim 11, wherein establishing the bidirectional flow of the outputs between the convolutional neural network and the transformer neural network includes, during the iterative data refinement stage:
generating a first pseudo-label for the convolutional neural network using the second prediction from the transformer neural network; and
generating a second pseudo-label for the transformer neural network using the first prediction from the convolutional neural network.

13. The method of claim 12, wherein training a convolutional neural network and a transformer neural network comprises optimizing parameters of the convolutional neural network and the transformer neural network that minimize the cumulative loss based on the first pseudo-label and the second pseudo-label.

14. The method of claim 7, wherein the loss function comprises a self-supervised hybrid loss function based on an amplitude loss, a frequency loss, and a reconstruction loss based on the first pseudo-label and the second pseudo-label.

15. The method of claim 14, wherein the reconstruction loss comprises a sum of (i) a first loss between the first prediction and the first pseudo-label and (ii) a second loss between the second prediction and the second pseudo-label.

16. The method of claim 1, further comprising adding Gaussian noise during the training, wherein the Gaussian noise is sampled from a normal distribution with zero mean.

17. The method of claim 1, further comprising performing elastic full-waveform inversion using the enhanced seismic data to generate a velocity model of the subsurface formation.

18. The method of claim 17, further comprising determining at least one of: a well placement, a trajectory, a completion strategy, or a production optimization, based on the velocity model.

19. A system for seismic data processing, the system comprising:
at least one seismic sensor configured to generate seismic data associated with a surface formation;
at least one processor configured to:
receive the seismic data associated with the subsurface formation;
train a convolutional neural network and a transformer neural network in a self-supervised cross-training framework, wherein to train the convolutional neural network and the transformer neural network, the at least one processor is configure to:
generate training pairs by applying high-pass filtering to the seismic data;
generate, using the training pairs, a first prediction from the convolutional neural network and a second prediction from the transformer neural network; and
establish bidirectional flow of outputs between the convolutional neural network and the transformer neural network; and
apply the trained transformer neural network to the seismic data to generate enhanced seismic data.

20. A non-transitory computer readable medium storing computer-executable code for enhancing seismic data, the computer-executable code comprising:
code for receiving seismic data associated with a subsurface formation;
code for training a convolutional neural network and a transformer neural network in a self-supervised cross-training framework, wherein the code for training includes:
code for generating training pairs by applying high-pass filtering to the seismic data;
code for generating, using the training pairs, a first prediction from the convolutional neural network and a second prediction from the transformer neural network; and
code for establishing bidirectional flow of outputs between the convolutional neural network and the transformer neural network; and
code for applying the trained transformer neural network to the seismic data to generate enhanced seismic data.
